(19) United States
(12) Patent Application Publication
(10) Pub. No.: US 2018/0264319 A1
(43) Pub. Date: Sep. 20, 2018

(54) SYSTEM AND METHOD FOR DETECTING AND ANALYZING PLURALITY OF PLAY ITEM

(71) Applicant: CAMELLIO GONZALES, SENTINEL, OK (US)

(72) Inventor: CAMELLIO GONZALES, SENTINEL, OK (US)

(21) Appl. No.: 15/460,243

(22) Filed: Mar. 16, 2017

(51) Int. Cl. A63B 24/00; G09B 19/00; A63B 69/00; H02J 7/00

(52) U.S. Cl. CPC A63B 24/0006; A63B 24/0062; G09B 19/0038; A63B 69/0002; A63B 2220/803; A63B 2220/833; A63B 2220/12; A63B 2220/30; A63B 2220/56; H02J 7/0052

(57) ABSTRACT

The present invention relates to a method and a system for detecting and analyzing plurality of play items pertaining to baseball game i.e. baseball and baseball bat. The system includes sensors integrated to baseball and baseball bat, personal digital assistant, communication network, first lift band and second lift band. The baseball sensors sense the parameters which measures the performance of pitcher, while the baseball bat sensors sense the parameters which measures the performance of a batsman. The sensed data from baseball and baseball bat is transmitted to first and second lift band respectively, wherein the lift bands records the data and further transmit it to personal digital assistance device. The personal digital assistance device analyses the received data and display it on its display unit. The analyzed data is further transmitted to external computing device for better view of communication network formed between play items sensors, plurality of lift bands and personal digital assistance device.

### FIELD OF THE INVENTION

The present invention relates to at least one baseball training method. More particularly, the presently disclosed invention relates to system and method for detecting and analyzing plurality of play item pertaining to baseball game.

### BACKGROUND OF THE INVENTION

Baseball is a game of bat and ball between two teams who take turns batting and fielding. The batting team attempts to score runs by hitting a ball thrown by the pitcher by a bat swung by the batsman and running around a series of bases. The batting team attempts to score runs while the fielding team tries to prevent runs by getting the batman out. One of the pitching of the ball involves the gripping of the baseball and releasing it in a certain manner, and throwing it at a certain speed towards the batsman. The batsman focuses on contacting the ball through bat and run across the series of bases across the pitch to score runs.

The existing training methods for baseball players largely focus on building aerobic capacity of the player. Various exercises are and athletic regimes are carried out on a regular basis to develop power and endurance. The exercises focus on building muscle strength and elasticity of the muscles for pitching the ball as well as batting. Although, the existing methods of training focus on the repeated practice of the batting and pitching techniques, the constant practice with limited rest period for the players result in increase in wear and tear of the muscle tissues which may also lead to shoulder instabilities. Further, the existing training methods focus mainly on strength and power rather than on proper mechanics. The existing methods focus on developing consistency in playing through repeated pitching and batting exercise which also increases the fatigue rate amongst players.

Further limitations and disadvantages of conventional and traditional approaches will become apparent to one of skill in the art, through comparison of described systems with some aspects of the present disclosure, as set forth in the remainder of the present application and regarding the drawings.

### SUMMARY OF THE INVENTION

To overcome the disadvantages of the said above prior art the present invention provides a method and system for detecting and analyzing plurality of play items pertaining to a baseball game. The system herein includes a personal digital assistance device, a communication network, a first lift band and a second lift band, wherein plurality of play items is at least one baseball, and at least one baseball bat.

The at least one baseball is equipped with plurality of sensors, a global positioning system (GPS), at least one battery, and baseball sensor pad. The plurality of the sensor coupled to the at least one baseball is a thermos sensor that determines the position of fingers to be placed on the at least one baseball while pitching. Further the GPS rates the speed and distance of the at least one baseball when the at least one baseball is thrown while pitching. The at least one battery herein ensures the sufficient power supply to the plurality of the sensor placed in the at least one baseball. The baseball sensor pads work's when the potential energy is released. The baseball sensor pads pick up the kinetic energy when the at least one baseball is thrown and recharge the batteries in the at least one baseball. The baseball sensor pad further record the swing of the at least one baseball in the game and further rate the most efficient power and contact swing of the at least one baseball in the game.

The at least one baseball bat houses a bat sensor pad to pick up kinetic energy when the at least one baseball bat is swung to hit the at least one baseball and further recharges the integrated batteries from the kinetic energy picked up from the swing of the at least one bat. The plurality of the sensors mounted on the at least one baseball bat determines the speed of the at least one baseball bat and the pound pressure applied to the at least one baseball when hit.

The invention further comprises a first lift band and a second lift band, wherein the first lift band is enabled to record the key elements for playing baseball. The key elements herein include at least one feature such as body movement of the pitcher, pitching motion until the pitcher completes pitching, battery life of the at least one baseball, battery life of the first lift band. The second lift band herein is configured to the at least one baseball bat and is enabled to record the speed, the pound pressure and every motion or the swings of the player during the training period. The data received from the second lift band is accessed on personal digital assistance devices shared over the communication network by the player.

The first and the second lift band herein is further synced with personal digital assistance device, wherein the personal digital assistance device includes a computer implemented method. The computer implemented method of the personal digital assistance includes a pitch mode, first sync mode and a play catch mode. The pitch mode application on the computing device enables the computing device to record the rotation of the at least one baseball, movement of the at least one baseball, notes the placement of the fingers of at least one player on the at least one baseball and further enables the player to view the distance to which the at least one baseball was thrown during the game. The first sync mode is enable to analyze the resulted output of the pitch mode and of the play catch mode to give out the final outcome. The computer implemented method further is enables to record the information of the plurality of the sensor couples to the at least one baseball and to the at least one baseball bat.

The above-mentioned features and advantages of the present disclosure may be appreciated from a review of the following detailed description of the present disclosure, along with the accompanying figures in which like reference numerals refer to like parts throughout.

### BRIEF DESCRIPTION OF THE DRAWINGS:

The accompanying drawings illustrate the various embodiments of arrangements, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 illustrates a perspective view of the system in accordance with at least one embodiment of the invention.

FIG. 2 illustrates the internal view of the at least one baseball in accordance to the at least one embodiment of the invention.

FIG. 3 illustrates the internal view of the at least one baseball bat in accordance to the at least one embodiment of the invention.

FIG. 4 illustrates the flow chart view of the system in accordance to the at least one embodiment of the invention.

### DETAIL DESCRIPTION OF THE INVENTION

The present disclosure is best understood regarding the detailed figures and description set forth herein. Various embodiments are discussed below regarding the figures. However, those skilled in the art will readily appreciate that the detailed descriptions given herein with respect to the figures are simply for explanatory purposes as the methods and systems may extend beyond the described embodiments. For example, the teachings presented and the needs of an application may yield multiple alternative and suitable approaches to implement the functionality of any detail described herein. Therefore, any approach may extend beyond the implementation choices in the following embodiments described and shown.

References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

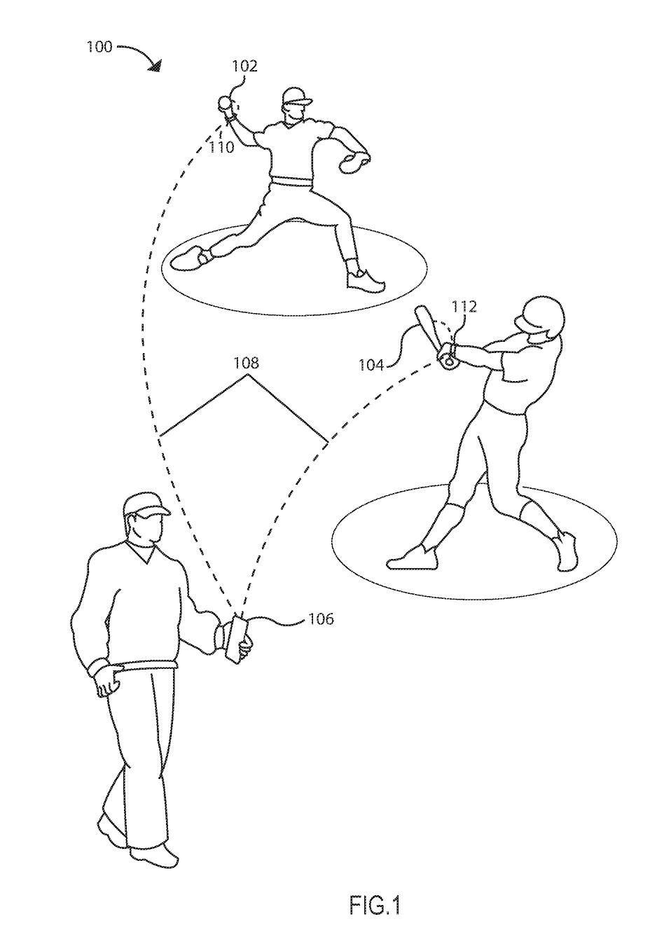

FIG. 1 illustrates a system [100] for detecting and analyzing plurality of play items including at least one baseball [102], at least one baseball bat [104], a personal digital assistance device [106], a communication network [108], a first lift band [110] and a second lift band [112]. Herein, the first lift band [110] is configured to the at least one baseball [102] and the second lift band is configured to the at least one baseball bat [104].

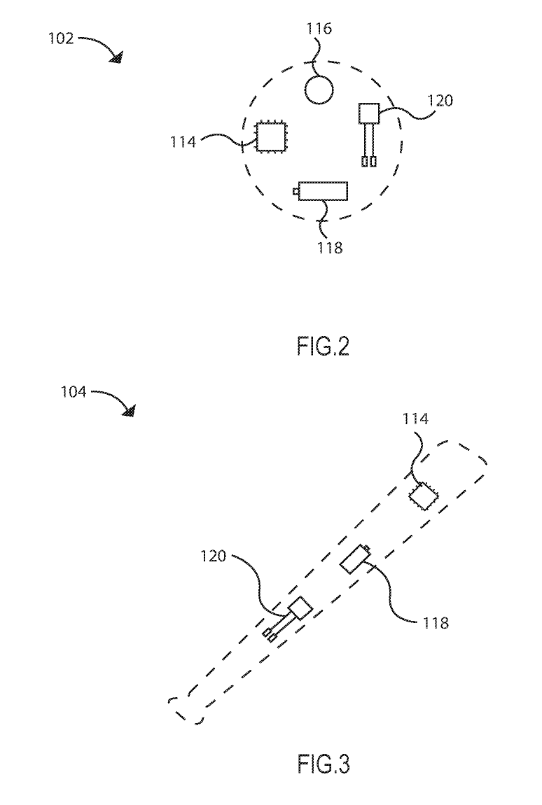

FIG. 2 illustrates an internal view of the at least one baseball [102], wherein the at least one baseball [102] is equipped with plurality of sensors [114], a global positioning system (GPS) [116], at least one battery [118] and at least one baseball sensor pad [120]. The plurality of sensor [114] couple to the at least one baseball [102] is a thermos sensor which determine the position of fingers of the player placed on the at least one baseball [102] while pitching. Further the GPS [116] rates the speed and distance of the at least one baseball [102] when the at least one baseball [102] is thrown while pitching. The at least one battery [118] enable providing sufficient power supply to the plurality of the sensor [114] placed in the at least one baseball [102]. The at least one battery [118] are of the size to fit inside an average baseball [102], yet not increasing the weight of the at least one baseball [102] beyond the prescribed weight. The at least one baseball [102] also comprises at least one baseball sensor pad [120] which work when the potential kinetic energy is released and further recharges the integrated at least one battery [118] coupled to the at least one baseball [102] from the picked up kinetic energy. The at least one baseball sensor pad [120] also records the swing of the at least one baseball [102] in the game, rate the most efficient power and contact swing of the at least one baseball [102] in the game.

FIG. 3 illustrates the internal view of the at least one baseball bat [104], wherein the at least one baseball bat [104] houses plurality of the sensor [114], baseball sensor pad [120] and at least one battery [118]. The plurality of the sensor [114] herein determines the speed of the at least one baseball bat [104] and the pound pressure applied to the at least one baseball [102] when hit. The baseball sensor pad [120] enable picking up the kinetic energy of the at least one baseball bat [104] and further recharges the integrated at least one battery [118] coupled to the at least one baseball bat [102] from the picked up kinetic energy.

The system herein further comprises a first lift band [110] as a wearable device to be worn by pitcher. The first lift band [110] records the key elements for playing baseball game, wherein the key element includes at least one of a body movement of the pitcher, a pitching motion until the pitcher completes pitching, a battery life of the at least one baseball, battery life of the first lift band [110]. Herein, the first lift band [110] includes three modes: a pitch mode, a play catch mode and a first sync mode. The pitch mode enables the player to record the pitching mechanics and see the distance & speed with which at least one baseball [102] is thrown while pitching. The play catch mode enables the player to see the maximum distance and the top speed with which the at least one baseball [102] is to be thrown while pitching. While the first sync mode enables the player to sync the play catch mode data and pitch mode data to the player's personal digital assistant devices [106] to share the analyzed information over the communication network [108].

The second lift band herein [112] is configured with the at least one baseball bat [104], wherein the second lift band enables providing a note of the recorded speed, pound pressure, and every motion & swing of the at least one baseball bat [104] during the training period of the player. The data received from the second lift band [112] is accessed on personal digital assistant devices [106] shared over the communication network [108] by the player. Further, the second lift band [112] displays the at least one battery [118] life of the at least one baseball bat [104] and of the second lift band [112].

The at least one baseball [102] and the at least one baseball bat [104] synced to the first lift band [110] and to the second lift band [112] respectively are further synced with personal digital assistant devices [106]. The personal digital assistance device [106] herein is enabled to be accessed either by a pitcher, a batsman or by third person providing training to either pitcher, batsman or both. The personal digital assistant devices [106] comprises of a computer implemented method having three modes: a pitch mode, a play catch mode and a first sync mode. The pitch mode on the personal digital assistant devices [106] enables the user to view following on its display unit: the rotation of the at least one baseball [102], movements of the at least one baseball [102], the placement of the fingers on the at least one baseball [102], the arm angle of the pitcher when the at least one baseball [102] was thrown and the speed with which the at least one baseball [102] was thrown while pitching on its display unit. Further, the play catch mode enables the player to view following on its display unit: the distance at which the at least one baseball [102] was thrown during the game. The first sync mode enables the user to sync the play catch mode data and pitch mode data of the user's personal digital assistant devices [106] for sharing the analyzed information over external computing device for better view of the training. Additionally, the recorded and analyzed the at least one baseball [102] training information is shared with baseball organization. The computing device herein includes at least one of a server laptop, mobile, smart glasses or the combination thereof.

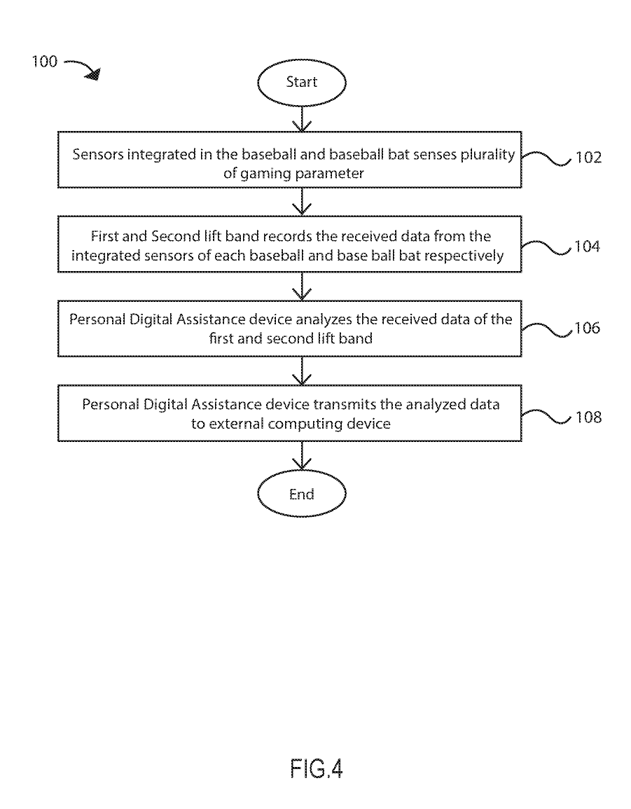

FIG. 4 illustrates the flow chart view [100] of the present system which enables detecting and analyzing plurality of play items including the at least one baseball [102] and at least one baseball bat [104] which pertains to a baseball game.

Step. 102 of FIG. 2 illustrates sensing a plurality of gaming parameter relating to at least one baseball and to at least one baseball bat. The at least one baseball herein is equipped with plurality of sensors, wherein the plurality of sensor couple to the at least one baseball is a thermos sensor which is enabled to determine the position of fingers of the player placed on the at least one baseball while pitching. The plurality of the sensor mounted to the at least one baseball bat determines the speed of the at least one baseball bat and the pound pressure to the at least one baseball when hit.

Step. 104 of FIG. 2 illustrates creating a record of the received input data from the plurality of the sensor via plurality of lift band. The present system herein consists of a first lift band and a second lift band, wherein the first lift band is configured to make a note or a record of the various gaming related parameters of the at least one baseball and the second lift band is enable to make a note/remark of the various gaming parameters relating to the at least one baseball bat. The various gaming parameters for which the first lift band makes a record includes at least one of that is a body movement of the pitcher, a pitching motion until the pitcher completes pitching, a battery life of the at least one baseball, battery life of the first lift band. The various gaming parameters for which the second lift band makes a record includes at least one of speed, pound pressure, and every motion and swing during the training period of the player. The data received from the second lift band is accessed on personal digital assistant devices shared over the communication network

Step. 106 of FIG. 2 illustrates analyzing the created record by the personal digital assistance device, wherein the personal digital assistance device is integrated with a computer implemented method and enable the user to view the analyzed data on its display unit. The personal digital assistance device also comprises a first sync mode which enables the user to sync the pitcher data with the batsman data and transmitting this data over external computing device for better view of communication network.

Step. 108 of FIG. 2 illustrates transmitting an analyzed record output to an external computing device for a better view over a communication network. Once the recorded information is being analyzed the personal digital assistant devices shares the recorded and analyzed the at least one baseball training information to external computing devices for better view of the training over the communication network. Additionally, the recorded and analyzed the at least one baseball training information is shared with baseball organization also.

While the present disclosure has been described regarding certain embodiments, it will be understood by those skilled in the art that various changes may be made and equivalents may be substituted without departing from the scope of the present disclosure. In addition, many modifications may be made to adapt a situation or material to the teachings of the present disclosure without departing from its scope. Therefore, it is intended that the present disclosure not be limited to the embodiment disclosed, but that the present disclosure will include all embodiments falling within the scope of the appended claims.

What is claimed:

1. (canceled)

2. (canceled)

3. (canceled)

4. (canceled)

5. (canceled)

6. (canceled)

7. (canceled)

8. (canceled)

9. (canceled)

10. (canceled)

11. A method of training a player to play baseball, comprising the steps of:
providing an improved baseball including:
a main body including:
an outer covering; and
an interior volume;
a plurality of sensors;
wherein said plurality of sensors are located upon and attached to said outer covering; and
wherein said plurality of sensors are adapted to determine the position of fingers of a player gripping said improved baseball;
a kinetic energy member;
wherein said kinetic energy member is located within said interior volume of said main body and is adapted to transform kinetic energy of said improved baseball into electric power and send said electric power into a rechargeable battery;
a GPS member;
wherein said GPS member is located within said interior volume of said main body and is adapted to send electronic signals remotely to a GPS system to thereby provide location and velocity information of said improved baseball;
at least one rechargeable battery;
wherein said at least one rechargeable battery is located within said interior volume of said main body, is electrically connected to said kinetic energy member, said GPS member, and to said plurality of sensors, is adapted to provide electric power to said sensors and said GPS member, and is adapted to receive electric power from said kinetic energy member;
providing an improved baseball bat including:
a main body including:
an outer shell; and
an interior volume;
at least one sensor;
wherein said at least one sensor is located upon and attached to said outer shell; and
wherein said at least one sensor is adapted to measure the pressure applied to said outer shell by said improved baseball when said bat is used to hit said improved baseball;
a kinetic energy member;
wherein said kinetic energy member is located within said interior volume of said main body and is adapted to transform kinetic energy of said improved baseball bat into electric power and send said electric power into a rechargeable battery;
a GPS member;
wherein said GPS member is located within said interior volume of said main body and is adapted to send electronic signals remotely to a GPS system to thereby provide location and velocity information of said improved baseball bat;
at least one rechargeable battery;
wherein said at least one rechargeable battery is located within said interior volume of said main body, is electrically connected to said kinetic energy member, said GPS member, and to said at least one sensor, is adapted to provide electric power to said at least one sensor and said GPS member, and is adapted to receive electric power from said kinetic energy member;
providing a GPS system;
wherein said GPS system is adapted to receive electronic signals from said GPS members of said improved baseball and said improved baseball bat, and send electronic signals to a receiver within a computer member;
providing a first wrist band including:
a main housing;
at least one attachment member;
wherein said at least one attachment member is adapted to releasably attach said main housing to a wrist of a pitcher;
a computer member including:
computer software encoded thereon;
wherein said computer member is located within said main housing;
a receiver;
wherein said receiver is located within said main housing and is adapted to receive said electronic signals from said GPS system;
a display screen;
wherein said display screen is located upon an outer surface of said main housing and is adapted to display information from said computer member;
at least one rechargeable battery;
wherein said at least one rechargeable battery is adapted to provide electric power to said computer member, said receiver, and said display screen;
wherein said first wrist band is adapted to be worn by a pitcher on their wrist and provide location, velocity, and motion information of said improved baseball after said improved baseball has been thrown by said pitcher;
providing a second wrist band including:
a main housing;
at least one attachment member;
wherein said at least one attachment member is adapted to releasably attach said main housing to a wrist of a batter;
a computer member including:
computer software encoded thereon;
wherein said computer member is located within said main housing;
a receiver;
wherein said receiver is located within said main housing and is adapted to receive said electronic signals from said GPS system;
a display screen;
wherein said display screen is located upon an outer surface of said main housing and is adapted to display information from said computer member;
at least one rechargeable battery;
wherein said at least one rechargeable battery is adapted to provide electric power to said computer member, said receiver, and said display screen;
wherein said second wrist band is adapted to be worn by a batter on their wrist and provide location, velocity, and motion information of said improved baseball bat, and any applied pressure to said outer shell by said improved baseball after said improved baseball bat has been used by said batter to swing and hit said improved baseball;
wherein said method of training a player to play baseball can be used to train and improve the performance of pitchers and hitters during their training sessions.

12. The method of training a player to play baseball of claim 11, further includes the step of:
providing a personal digital assistance device including:
a main housing;
a computer member including:
computer software encoded thereon;
wherein said computer member is located within said main housing;
a receiver;
wherein said receiver is located within said main housing and is adapted to receive said electronic signals from said GPS system;
a display screen;
wherein said display screen is located upon an outer surface of said main housing and is adapted to display information from said computer member;
at least one rechargeable battery;
wherein said at least one rechargeable battery is adapted to provide electric power to said computer member, said receiver, and said display screen;
wherein said personal digital assistance device is adapted to be accessed either by a pitcher, a batter, or by a third person helping to train players to play baseball to help monitor and provide feedback and instructions to said pitcher and batter training at the same time.

13. The method of training a player to play baseball of claim 12, wherein said computer software of said computer member of said personal digital assistance device includes:
three modes:
a pitch mode;
wherein said pitch mode is adapted to enable a user to view the rotation and movements of said improved baseball, and the placement of fingers upon said improved baseball;
a play catch mode;
wherein said play catch mode is adapted to enable a user to view the distance to which said improved baseball was thrown during a given time period; and
a synchronization mode;
wherein said synchronization mode is adapted to enable a user to synchronize data derived from said play catch mode to data derived from said pitch mode, analyze said synchronize data, and make said synchronize data available to other external devices.

14. The method of training a player to play baseball of claim 13, wherein said personal digital assistance device is chosen from a list of personal digital assistance devices consisting of a server laptop, a mobile device, and smart glasses.

15. The method of training a player to play baseball of claim 13, further includes the step of:
providing an external device;
wherein said external device is adapted to generate and send reports of said analyzed synchronize data to other players and sports organizations.

16. The method of training a player to play baseball of claim 11, wherein said plurality of sensors are formed as thermostatic sensors adapted to detect heat from a players fingers upon said baseball.

17. The method of training a player to play baseball of claim 11, wherein said GPS system is adapted to determine the speed and distance of said improved baseball when thrown by a pitcher.

18. The method of training a player to play baseball of claim 11, wherein the improved baseball has a weight substantially similar to a standard baseball.
